(19) United States
(12) Patent Application Publication
(10) Pub. No.: US 2005/0141453 A1
(43) Pub. Date: Jun. 30, 2005

(54) Resource allocation in mobile network

(75) Inventor: Yuan Zhu, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/795,229

(22) Filed: Mar. 9, 2004

(30) Foreign Application Priority Data
Dec. 31, 2003 (FI) 20031935

(51) Int. Cl. H04Q 7/00; H04Q 7/20; H04B 7/212

(52) U.S. Cl. 370/331; 455/436; 370/348

(57) ABSTRACT

A mobile network using time division multiple access, the network comprising means for collecting information on inter-cell handovers in the mobile network, means for maintaining a network topology on the basis of the collected inter-cell handover information, the network topology dynamically defining one or more neighboring cells for a given cell and means for allocating, at the given cell, to a mobile terminal a time slot on the basis of load situation in the neighboring cells defined by the dynamically maintained network topology.

### FIELD

The invention relates to allocation of radio resources in a mobile network.

### BACKGROUND

In a cellular radio system using Time Division Multiple Access (TDMA), when allocating a radio resource to a user equipment (UE), the network has to consider as one allocation parameter the time slot that shall be allocated to the UE. For instance, in 3GPP UTRA (Universal Mobile Telephony System Terrestrial Radio Access) TDD (Time Division Duplex) using both TDMA and Code Division Multiple Access (CDMA), several UEs separated by a spreading code can utilize the same time slot. Besides the load in the same cell using the same time slot, the level of noise experienced by a UE depends also on the degree of utilization of the corresponding slot in neighbouring cells. So careful design of the slot allocation strategy in Base Transceiver Stations (BTS) plays an important role in distributing the traffic to all the slots optimally.

In determining which timeslot to allocate to a user, prior art recognizes a random-number-based algorithm and a semi-static resource allocation algorithm. Both methods aim to balance and distribute traffic and also interference equally. In the random-number-based algorithm, the RNC picks up a time slot for a UE randomly.

The semi-static allocation method divides all slots into groups, such as own and borrowed in order to decrease the possible collision of neighbouring BTSs during resource allocation. For instance, a certain time slot can be defined as “own” for a certain cell and is then defined as “borrowed” in a neighbouring cell. Then a UE being close to a BTS could be allocated a “borrowed” slot and a UE being far from a BTS could be allocated a slot defined as “own”. The semi-permanent allocation method, in order to operate properly, is practically dependent on the use of physical location of BTSs as an allocation parameter. The location of the BTSs is usually determined in the configuration stage of the network, e.g. by using GPS (Global Positioning System).

The success of prior art slot allocation methods is to an excessive tent dependent on relative location information between the BTSs. The known The object of the present invention is to provide an improved method are geographically close to each other but because of azimuth there is no or a low level of interference between them.

### SUMMARY OF THE INVENTION

The object of the present invention is to provide an improved method and apparatus for allocating resources in a radio network. According to one embodiment, the invention provides a resource allocation method in a mobile network using time division multiple access, the method comprising steps of collecting information on inter-cell handovers in the mobile network, maintaining a network topology on the basis of the collected inter-cell handover information, the network topology dynamically defining one or more neighboring cells for a given cell, and allocating, at the given cell, to a mobile terminal a time slot on the basis of the time slot allocation situation in the neighboring cells defined by the dynamically maintained network topology.

According to one embodiment, the invention provides a mobile network using time division multiple access, the network comprising means for collecting information on inter-cell handovers in the mobile network, means for maintaining a network topology on the basis of the collected inter-cell handover information, the network topology dynamically defining one or more neighboring cells for a given cell, and means for allocating, at the given cell, to a mobile terminal a time slot on the basis of the time slot allocation situation in the neighboring cells defined by the dynamically maintained network topology.

In the invention, there is provided a method and apparatus to dynamically define the network that adapts to the usage of the network. The dynamically defined network topology is utilized when allocating resources to UEs. Time slot allocation situation in neighboring cells can cover concepts such as: number of users in one slot, transmission/reception power in slot or FER (Frame Error Frequency) in a slot, for instance.

The invention is applicable in a network using TDMA, especially in systems using both time and code divisional multiple access when neighboring cells can operate on same frequency bands and the selection of a timeslot for a new user is of vital importance. Examples of such systems include WCDMA TDD or Chinese TD-SCDMA.

The invention is independent of the duplex method of the network and can thus be used in a network employing Time Division Duplex (TDD) or Frequency Division Duplex (FDD). The invention is also independent of the direction of the traffic and can thus be utilized in allocation of the timeslot both in uplink and in downlink direction.

The invention provides significant advantages. The resource allocation is based on a dynamically adapting network topology, which is not only based on physical distances between base stations but takes into account how the network is being used. The proposed solution significantly improves resource allocation in a TDMA network significantly.

### DRAWINGS

In the following, the invention will be described in greater detail with reference to the preferred embodiments and the accompanying drawings, in which:

FIG. 1 illustrates a telecommunication network by way of an example;

FIG. 2 shows on example of the method according to the invention;

FIG. 3 illustrates allocation of timeslots in a base station configuration; and

FIG. 4 shows one embodiment of the network structure according to the invention.

### DETAILED DESCRIPTION

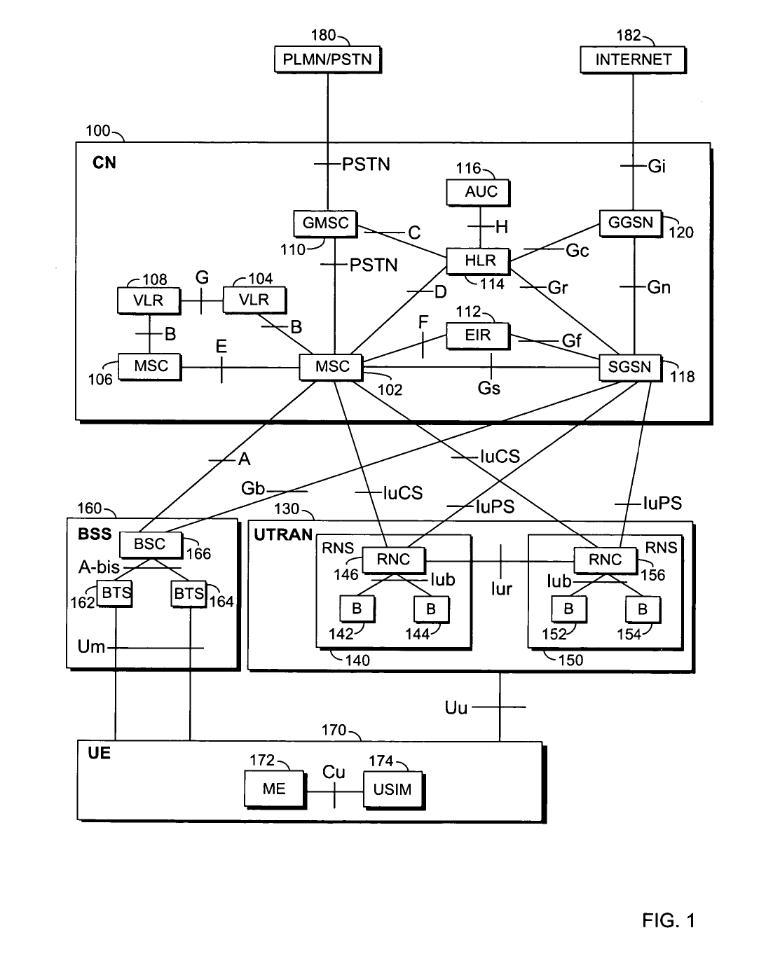

FIG. 1 is a simplified block diagram showing the most important parts of a radio system at network element level and the interfaces between the network elements. The example of FIG. 1 illustrates a radio network comprising parts of a 2/2.5-generation GSM (Global System for Mobile communication) and 3.generation UMTS (Universal Mobile Telephony System) networks. Besides the network shown in FIG. 1, the invention can also be used in other radio networks employing TDMA or TD-CDMA. One example of such a network is the Chinese TD-SCDMA (Time Division Synchronized CDMA), which is based on the 3GPP UTRA TDD with narrowband carriers.

In FIG. 1, the structure and functions of the network elements are not described in detail since they are generally known. The main parts of the shown radio system include a core network (CN) 100, a radio access network (UTRAN) 130 and a user equipment (UE) 170. Radio access network UTRAN 130 belongs to the third generation and is implemented by the wideband code division multiple access technology (WCDMA). The figure also shows a TDMA implemented base station system 160 belonging to the 2/2.5 generation.

In FIG. 1, the structure of the core network 100 illustrates a combined structure of the GSM and GPRS (General Packet Radio System) systems. GSM network elements provide the implementation of circuit-switched connections, and GPRS network elements provide implementation for the packet-switched connections. In the core network, a mobile services switching center (MSC) 102 is the core of the circuit-switching functionality. The same MSC 102 can be used to serve the connections from both UTRAN 130 and BSS 160. The tasks of MSC 102 include for instance connection switching, paging, user equipment location registration, handover management, subscriber billing information collection, encryption parameter management, frequency allocation management and echo cancellation. The number of MSCs 102 may vary. A small network operator may have only one MSC 102, but there may be several of them in large core networks 100.

Large core networks 100 may comprise a separate gateway mobile service switching center (GMSC) 110 that attends to the circuit-switched connections between the core network 100 and external networks 180. GMSC 310 is located between the MSCs 302, 306 and the external networks 380. The external network 380 may be for instance a public land mobile network (PLMN) or a public switched telephone network (PSTN).

A home location register (HLR) 114 comprises a permanent subscriber register, whereas a visitor location register (VLR) 104 includes roaming-related information on the UE 170 in the area of the MSC 102. An equipment identity register (EIR) 112 includes the international mobile equipment identities (IMEI) of the UE 170 employed in the radio system and an authentication center (AuC) 116 includes functionality for UE authentication.

A serving GPRS support node (SGSN) 118 is the core of the packet-switching functionality of the core network 100. The main task of SGSN 118 is to transmit and receive packets between the UE 170 and UTRAN 130 or BSS 160. A gateway GPRS support node (GGSN) 120 is the counterpart to GMSC 110 on the packet-switching side. In the example of FIG. 1, the external network 182 is the Internet.

BSS 160 contains a base station controller (BSC) 166 and base transceiver stations (BTS) 162, 164 implementing the radio path and the related functions. BSC 166 attends for example to the following tasks: BTS radio resource management, inter-cell handover, frequency management, frequency hopping sequence management, uplink time delay measurement, implementation of operation and maintenance interface, and power control. Each BTS 162, 164 comprises at least one transceiver that implements one carrier having eight timeslots in GSM. Typically, one BTS serves one cell, but a single BTS can also serve several sectorial cells. The diameter of a cell may vary from some meters to several kilometers.

The radio access network 130 contains radio network subsystems (RNS) 140, 150. Each RNS 140, 150 includes radio network controllers (RNC) 146, 156 and node Bs 142, 144, 152, 154, that is, base stations. The functionality of RNC 140, 150 corresponds approximately to the functionality of BSC 166 and the functionality of node B 142, 144, 152, 154 corresponds to the functionality of BTS 162, 164 of the GSM system.

The user equipment 170 includes two parts, mobile equipment (ME) 172 and UMTS subscriber identity module (USIM) 174. USIM 174 includes user-related information and particularly data related to information security, for example an encryption algorithm. The GSM system naturally uses the system's own identity module. UE 170 comprises at least one transceiver for implementing a radio connection UTRAN 130 or to BSS 160.

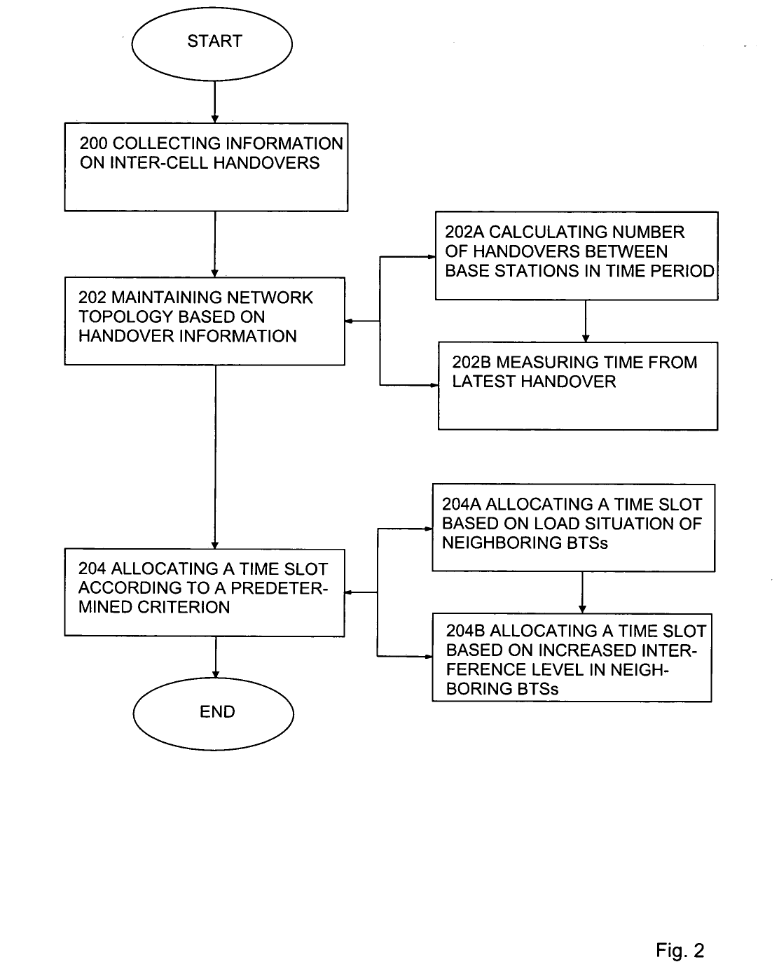

FIG. 2 illustrates one example of a method according to the invention. The invention is applicable in a network using both time and code division multiple access. In such systems there are several time slots in both transmission directions that can be allocated to a mobile terminal. Several users can be served simultaneously in each time slot and one user can also simultaneously be served in several time slots. So, resource allocation to a newly added UE or a UE handed over from a neighboring cell, the time slot has to be considered as one allocation parameter.

In step 200, the network collects information about inter-cell handovers between cells provided by a single base station and between cells provided by different base stations. An inter-base station handover can occur under a certain BSC/RNC, between BSC/RNCs or between MSCs. Handover information can be extracted from signaling between the MS and the network and from signaling within the network. In one embodiment of the invention, the network will collect and store the originating cell, the receiving cell and the time moment of the handover from each occurred handover. FIG. 2 illustrates the method from the viewpoint of inter-cell handover between base stations but the method is applicable to inter-cell handover within a single base station as well.

In step 202, the network maintains the network topology on the basis of the handover information. In maintaining the network topology, the network can calculate number of handovers between base stations in a given time period as illustrated by step 202A. For instance, the time period can be one hour. In the network topology, two base stations would be considered to be neighboring base stations if there has been a predetermined number of handovers between the two base stations within the last hour. Naturally, the length of the time period is not limited to one hour but can be of any desired length. Besides using the number of handovers within a time period as a criterion, the network can use some other criterion in defining the network topology. For instance, according to step 202B, the criterion can be the elapsed time from the latest handover. Then, if there has been a handover between two base stations within the last 15 minutes, these two base stations are considered to be neighboring base stations. Some combinational criteria could also be used. Then, for example, the network would require that there has been a handover within the previous half an hour and that there has been at least five handovers within the previous hour. If the criteria shown by steps 202A and 202B or some similar criteria are not fulfilled, two base stations or two cells in a single base station are no more considered to be neighboring cells.

Another example illustrates using a weight coefficient in deciding which time slot should be used for a new UE. For instance, the coefficient could be UE/hour meaning how often there has been a UE moving between two cells. Here, the smaller value the weight has, the less handover activity there is between cells and the further away two cells are considered to be from each other in the network topology sense.

As an example we can consider a situation where a UE wants to access a cell 1 having edge with cell 2 and cell 3. The weight coefficient formed from the activity between cell 1 and cell 2 could be 0.2 and the weight coefficient between cell 1 and cell 3 could be 0.8. Suppose that slot 2 of cell 2 is used by two UEs for uplink and that slot 3 of cell 3 is used by one UE for uplink. In decision-making, when choosing a time slot in cell 1, the coefficient for slot 2 would be 0.4 (0.2*2=0.4) and 0.8 for slot 3 (0.8*1=0.8). Then, the slot to be allocated to a new UE in cell 1 would be slot 2. Although slot 2 has more users than slot 3, the UE would still be added into slot 2 since cell 2 is further away from cell 1 than cell 3 from the topology point of view.

Naturally, the invention is not limited to the examples given above but also other criteria can be used to define the activity between two cells in a network. In step 202 the network would maintain a topology that defines the activity between all pairs of base stations between which there has been a handover at some point of time.

When maintaining the network topology, the network structure becomes clear more quickly the more UEs are in the system and thus the more handover reports are available. When using the method according to the invention, one can also gain information on traffic density at different moments of the day or week, for instance.

In step 204, the network allocates a time slot to a mobile station according to a predetermined criterion. Allocation of a time slot to a mobile terminal is needed when a mobile terminal enters a cell or when a mobile terminal starts a new connection within a cell. As illustrated by step 204A, a time slot is allocated based on load situation in neighboring BTSs. Here, neighboring BTS is defined by a procedure defined by steps 200 to 202, where handover information is collected and the activity between base stations is assessed. Then, in step 204A, the load of a neighboring base station can be assessed by availability of time slots, for instance. If a certain time slot is completely unused in neighboring base stations, such a time slot could be allocated to a mobile terminal. Or in a TD-CDMA system, where there may be several users in each time slot, a time slot with the lowest number of users could be allocated to a new mobile terminal.

Step 204B illustrates that in selection of a time slot a time slot with the lowest increased interference could be allocated to a terminal. Increase of interference could be estimated by estimating the total transmission power or data rate in each time slot that is used by neighboring base stations and the given base station performing the allocation of the resource. Then, for a new mobile terminal, a time slot having the lowest total transmission power or lowest total data rate in the neighboring base stations and the current base station could be chosen.

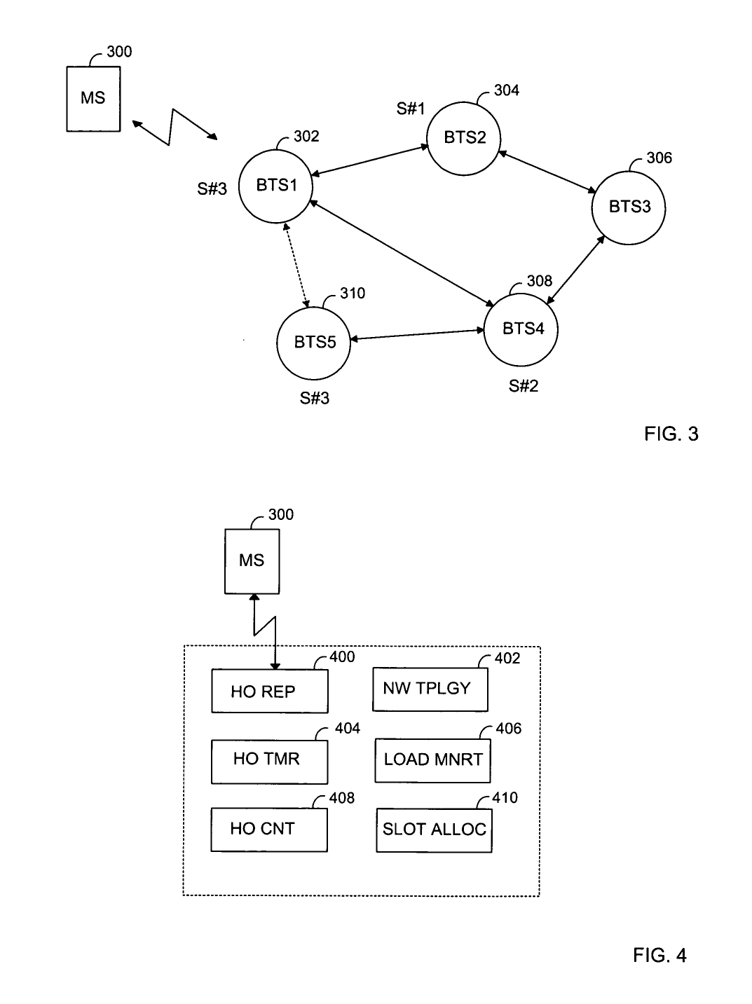

FIG. 3 illustrates one resource allocation situation in a mobile network. The network comprises base stations 302 to 310, each providing at least one cell. Table 1 shows the previous activity between the base stations 302 to 310.

TABLE 1
Handover data structure

| First BTS | Second BTS | HO/hour | Latest HO |
|---|---|---|---|
| BTS1 | BTS2 | 5 | 1/9/2003 9 am |
| BTS1 | BTS4 | 6 | 1/9/2003 1 pm |
| BTS1 | BTS5 | 0 | 28/8/2003 9 am |
| BTS2 | BTS3 | 7 | 1/9/2003 11 am |
| BTS4 | BTS5 | 10 | 2/9/2003 10 am |

Table 1 includes a column “HO/hour”, which indicates the number of handovers during the busiest hour within the latest week, for instance. Column “Latest HO” indicates the moment when the latest HO has occurred. The database/data structure containing the handover activity information could as well contain a column such as number of the handovers within the latest hour, the number of handovers from a certain moment of time or some similar column. When maintaining the network topology, BTS5 might be dropped out from being a neighbor base station to BTS both when using the number of HOs during the busy hour or the time moment of the latest HO as a decision parameter.

In FIG. 3, a mobile terminal 300 is about to attach to the base station 302 by entering the cell, that is, the audibility area of the base station 302. Base station 302 has currently two neighboring base stations, BTS2 304 and BTS4 306. BTS5 310, although being the closest base station to the base station 302, is currently not considered to be a neighboring base station, which is illustrated by a dashed line. Base station BTS2 is currently using time slot S#1 and base station BTS4 is using time slot S#2. Base station BTS5 is using time slot S#3 but because BTS5 is not considered to be a neighboring base station to base station BTS1, time slot S#3 could be allocated to the terminal 300.

FIG. 4 illustrates one possible network setup for performing the tasks relating to the invention. Mobile station 300 transmits handover reports to means 400 for collecting and storing handover reports. Alternatively, report collecting means 400 forms handover information from signaling between the mobile station 300 and the network. A handover report contains information such as the handover originating cell, handover receiving cell and the time moment of the handover.

The network also includes means 402 for maintaining network topology. Topology is updated by using the handover reports. In updating the topology, the updating means 402 can use handover timer 404 keeping time since the latest handover between certain base stations. Alternatively, the time since the latest handover can be calculated from the handover reports. Updating means 402 can also utilize a counter 408 for counting the number of handovers between certain base stations within a predetermined period of time. Alternatively, the number of handovers between base stations could be found out by making a query every five minutes to a database including the handover reports.

The network can also include means 406 for monitoring load in base stations. Load monitoring means 406 can be aware of load in all base stations in the network. Monitoring means 406 can also be aware of slot allocation in various base stations and can estimate increase in interference with different slot allocation alternatives. Slot allocation means 410 can make the decisions how slots should be allocated by using the information provided by the load monitoring means 406.

FIG. 4 is a general level presentation of the functionality needed in the network to implement some embodiments of the invention. The functional entities shown in FIG. 4 can be distributed in various places in the network. For example, report collecting means 400 can be implemented partly in a base station and partly in a radio network controller. Other means shown in FIG. 4 can be implemented in a BSC/RNC, for instance.

The functionality of the invention can be implemented as software, ASIC (Application Specific Integrated Circuit) or separate logic components, for instance.

Even though the invention has been described above with reference to an example according to the accompanying drawings, it is clear that the invention is not restricted thereto but can be modified in several ways within the scope of the appended claims.

1. A resource allocation method in a mobile network using time division multiple access, the method comprising:
collecting information on inter-cell handovers in the mobile network;
maintaining a network topology on a basis of the collected inter-cell handover information, the network topology dynamically defining one or more neighboring cells for a given cell; and
allocating, at the given cell, to a mobile terminal a time slot on the basis of time slot allocation situation in the neighboring cells defined by dynamically maintained network topology.

2. The method of claim 1, wherein the step of maintaining further comprises:
considering a cell that has a number of inter-cell handovers per time unit with the given cell exceeding a predetermined threshold value to be a neighboring cell to a given cell.

3. The method of claim 1, wherein the step of maintaining further comprises:
considering a cell that has had an inter-cell handover with the given cell within a predetermined time period to be a neighboring cell to a given cell.

4. The method of claim 1, wherein the step of allocating comprises:
allocating to a mobile terminal such a time slot that is unused in one or more neighboring cells.

5. The method of claim 1, wherein the step of allocating comprises:
allocating to a mobile terminal such a time slot that has the lowest load in one or more neighboring cells.

6. The method of claim 1, wherein the step of allocating comprises:
allocating to a mobile terminal a time slot, allocation of which introduces least interference in one or more neighboring cells.

7. The method of claim 1, wherein the mobile network uses time and code division multiple access.

8. A mobile network using time division multiple access, the network comprising:
collecting means for collecting information on inter-cell handovers in the mobile network;
maintaining means for maintaining a network topology on a basis of the collected inter-cell handover information, the network topology dynamically defining one or more neighboring cells for a given cell; and
allocating means for allocating, at the given cell, to a mobile terminal a time slot on the basis of time slot allocation situation in the neighboring cells defined by the dynamically maintained network topology.

9. The network of claim 8, wherein the maintaining means is configured to:
consider a cell that has a number of inter-cell handovers per time unit with the given cell exceeding a predetermined threshold value to be a neighboring cell to a given cell.

10. The network of claim 8, wherein the maintaining means is configured to:
consider a cell that has had an inter-cell handover with the given cell within a predetermined time period to be a neighboring cell to a given cell.

11. The network of claim 8, wherein the allocating means is configured to:
allocate to a mobile terminal such a time slot that is unused in one or more neighboring cells.

12. The network of claim 8, wherein the allocating means is configured to:
allocate to a mobile terminal such a time slot that has a lowest load in one or more neighboring cells.

13. The network of claim 8, wherein the allocating means is configured to:
allocate to a mobile terminal a time slot, allocation of which introduces least interference in one or more neighboring cells.

14. The network of claim 8, wherein the mobile network uses time and code division multiple access.
